(19) United States
(12) Patent Application Publication
(10) Pub. No.: US 2021/0046838 A1
(43) Pub. Date: Feb. 18, 2021

(54) Relay Control for Charging Points

(71) Applicants: Christian Müller-Winterberg, Dorsten (DE); Hermann Obergünner, Remscheid (DE)

(72) Inventors: Christian Müller-Winterberg, Dorsten (DE); Hermann Obergünner, Remscheid (DE)

(73) Assignee: innogy SE, Essen (DE)

(21) Appl. No.: 16/992,565

(22) Filed: Aug. 13, 2020

(30) Foreign Application Priority Data
Aug. 13, 2019 (DE) 10 2019 121 774.1

(51) Int. Cl. B60L 53/62; H02J 7/00

(52) U.S. Cl. CPC B60L 53/62; H02J 2310/48; H02J 7/00711; H02J 7/00714

(57) ABSTRACT

In a method, a charge control signal indicative of a maximum current value with which an electric vehicle is to be charged is determined. A relay control signal indicative of an opening and/or closing of at least two relays comprised by a charging point is determined. The relay control signal is determined at least partially based on the charge control signal. The determined relay control signal is output to at least one of the at least two relays, and the determined charge control signal is output to the electric vehicle. Further, an apparatus, a charging point and a system are also disclosed.

### CROSS-REFERENCE TO RELATED PATENT APPLICATIONS

This patent application claims the benefit of German Patent Application No. 10 2019 121 774.1, filed Aug. 13, 2019, the entire teachings and disclosure of which are incorporated herein by reference thereto.

### FIELD

The invention relates to charging points and/or charging stations for charging electric vehicles, in particular a method for controlling relays of a charging point and/or charging station.

### BACKGROUND

Usually, alternating current charging stations or charging points (abbreviated to charging station or charging point in the following), which provide a maximum charging capacity of up to 22 kW, do not comprise their own alternating current rectifiers or inverters. Due to this fact, it is not possible for charging stations or charging points to independently regulate or control an electric current that can be used to charge/discharge an electric vehicle.

An electric vehicle, on the other hand, has a rectifier and a storage battery in accordance with the state of the art. The rectifier is controlled by a control unit of the electric vehicle such that an electric charging current is controlled or regulated. The control unit of the electric vehicle is connected to a control unit of the charging station or charging point by means of a so-called Control-Pilot (CP) line. A pulse width modulated (PWM) signal may be applied to the CP line. The PWM signal may have a duty cycle, wherein the exact value of the duty cycle is assigned to a current value (e.g. according to IEC standard 61851-1:2017 or SAE J 1772:2017-10-13). A charging station or charging point may use the duty cycle to inform the electric vehicle, in particular the electric vehicle control unit, how much current is available for charging (maximum). The electric vehicle's rectifier may then adjust accordingly so that the battery is also charged with this charging current.

A charging station known from the state of the art closes or opens a current path by means of an electrical relay (hereinafter referred to as a relay), so that an electric vehicle may be charged. Such an electrical relay usually comprises a maximum continuous current (hereinafter also referred to as I_{R,max}). With commercially available industrial relays, the I_{R,max} is 50 A. Relays with a higher I_{R,max} require a larger installation space and are considerably more expensive.

The standards IEC 61851-1:2017 or SAE J 1772:2017-10-13 allow a maximum charging current of more than 50 A. This means that the maximum charging current cannot be achieved with commercially available industrial relays, as the maximum charging current permitted or provided for by the standards is normally far higher than that of a relay.

### BRIEF SUMMARY OF SOME EXEMPLARY EMBODIMENTS

The present subject matter is therefore based on the task of reducing or avoiding the disadvantages known from the state of the art and, in particular, to achieve the maximum permissible charging current in accordance with the relevant standards (at the time of the application about 80 A) in a simple and cost-effective manner.

This task is solved by a method, an apparatus, a charging point, and a system as described herein.

According to a first aspect, a method is described, e.g. performed by at least one charging point, the method comprising:

Determining a charge control signal indicative of a maximum current value with which an electric vehicle is to be charged;

Determining a relay control signal indicative of an opening and/or closing of at least two relays comprised by a charging point, wherein the relay control signal is determined at least partially based on the charge control signal;

Outputting or causing the outputting of the determined relay control signal to at least one of the at least two relays; and

Outputting or causing the outputting of the specified charge control signal to the electric vehicle.

This method is carried out and/or controlled by an apparatus, e.g. a charging point or a charging station. For example, the method is carried out and/or controlled by using at least one processor of the charging point or the charging station.

In an exemplary embodiment according to all aspects, the charging point is a charging station.

According to another aspect of the invention, an apparatus is described which is adapted or comprises corresponding means to carry out and/or control a method according to the first aspect. Apparatuses of the method according to the first aspect are or comprise in particular one or more apparatuses according to this aspect.

According to the first aspect of the invention, an alternative apparatus is also described, comprising at least one processor and at least one memory comprising computer program code, wherein the at least one memory and the computer program code are adapted to carry out and/or control with the at least one processor at least one method according to the first aspect. A processor is to be understood, for example, as a control unit, a microprocessor, a microcontrol unit such as a microcontroller, a digital signal processor (DSP), an application-specific integrated circuit (ASIC) or a field programmable gate array (FPGA).

For example, an exemplary embodiment further comprises means for storing information such as a program memory and/or a main memory. For example, an exemplary apparatus of invention further comprises means for receiving and/or transmitting information via a network such as a network interface. For example, exemplary inventive apparatuses are interconnected and/or connectable via one or more networks.

An exemplary apparatus according to the first aspect comprises, for example, a data processing system which is set up in terms of software and/or hardware to be able to carry out the respective steps of an exemplary method according to the first aspect. Examples of a data processing system are a computer, a desktop computer, a server, a thin client and/or a portable computer (mobile device), such as a laptop computer, a tablet computer, a wearable, a personal digital assistant or a smartphone.

Further apparatuses may be provided, for example a server and/or for example a part or component of a so-called computer cloud, which dynamically provides data processing resources for different users in a communication system. In particular, a computer cloud is understood to be a data processing infrastructure according to the definition of the “National Institute for Standards and Technology” (NIST) for the English term “Cloud Computing”. An example of a computer cloud is a Microsoft Windows Azure Platform.

According to the first aspect of the invention, a computer program is also described which comprises program instructions which cause a processor to carry out and/or control a method according to the first aspect if the computer program runs on the processor. An exemplary program according to the invention may be stored in or on a computer-readable storage medium containing one or more programs.

According to the first aspect of the invention, a computer-readable storage medium is also described which contains a computer program according to the first aspect. A computer-readable storage medium may be, for example, a magnetic, electrical, electro-magnetic, optical and/or other type of storage medium. Such a computer-readable storage medium is preferably physical (i.e. “touchable”), for example it is designed as a data carrier device. Such a data carrier device is for example portable or permanently installed in a device. Examples of such a data carrier device are volatile or non-volatile random access memories (RAM) such as NOR flash memories or sequential access memories such as NAND flash memories and/or read-only memories (ROM) or read-write memories. Computer-readable shall be understood to mean, for example, that the storage medium can be read and/or written to by a computer or data processing equipment, such as a processor.

According to a second aspect, an apparatus is described for placement at or in a charging point, for example an apparatus according to the first aspect, the apparatus comprising:

at least one relay configured to detect or receive a relay control signal indicative of an opening and/or closing of at least two relays, wherein the apparatus opens or closes the at least one relay based on the relay control signal.

According to a third aspect of the invention, a system is also described comprising a plurality of apparatuses, in particular at least one apparatus according to the first aspect (e.g. a charging point or charging column); and an electric vehicle, the electric vehicle is configured to detect or receive a charge control signal (e.g. a charge control signal output by a method according to the first aspect), wherein after detecting or receiving of the charge control signal, the electric vehicle adjusts the maximum current value of the charge control signal.

The maximum current value of the charge control signal is adjusted, for example, by means of a rectifier included in the electric vehicle. The regulation may be carried out by a control or current unit which is also comprised in the electric vehicle.

In the following, exemplary features and exemplary embodiments according to all aspects are described in more detail:

In particular, a charging point is a connection point where an electric vehicle may be connected for charging. A charging station is further understood to be an apparatus (e.g. a charging column, charging box, charging unit or the like) which has one or more charging points for charging one or more electric vehicles. Each charging point also has a residual current switching device between an earth connection, via which electrical energy is supplied, and the respective charging point, which causes the supply of electrical energy to be switched off in the event of a fault current.

An electric vehicle—also referred to as a vehicle—is, for the purposes of the present object, in particular a vehicle that can be moved by means of its own electric drive. Such an electric vehicle is, for example, a moped, scooter, motorcycle, passenger car, van, truck, eScooter, ducktrain, boat, drone, helicopter, airplane or the like, to name only a few non-limiting examples. The electric vehicle comprises, for example, one or more drives. One such drive is for example an electric motor.

A charging point can be operatively coupled to an electric vehicle via a charging cable, so that in particular electrical energy for charging the electric vehicle can be transferred from the charging point to a battery comprised by the electric vehicle. In addition to such a power line, a charging cable usually includes a data line via which one or more control signals that influence the charging of the electric vehicle can be transmitted.

The object in all its aspects is compatible with all available electric vehicles, since no changes are required on the part of an electric vehicle. The electric vehicle may therefore be left unchanged. An electric vehicle usually has a control unit and a rectifier, so that the electric vehicle regulates the supply of the corresponding electrical energy according to a specified maximum charging current.

The maximum permissible charging current of commercially available industrial relays installed at charging points has so far been below the maximum permissible charging current defined according to the relevant standards. Often a relay is used which allows a maximum charging current (continuous current) of 50 A. In contrast, the standards that define the framework conditions for charging electric vehicles allow a maximum charging current (continuous current) of 80 A at the time of registration. Since the time required to charge electric vehicles is often perceived as too long, increasing the maximum charging current may significantly reduce the charging time required for an electric vehicle.

In principle, the object provides for at least two relays to be connected in parallel. The combination of two relays, which can also be controlled separately (e.g. according to demand), allows the maximum possible charging current to be greater than 50 A.

Each of the at least two relays used in accordance with all aspects of the subject matter comprise, inter alia, one or more of the following attributes (i) to (iii)

i) maximum charging current (continuous current) of a current value that is lower than the charging current defined according to the relevant standards, e.g. 50 A;
(ii) suitable for use in inverters; and
(iii) designed for use in temperature ranges such as those regularly encountered in the vicinity of charging points.

The maximum current value with which an electric vehicle may be charged is represented by a value which is also referred to as I_{L} in the following. The charge control signal is indicative of such a maximum current value. The maximum (charging) current value is determined, for example, by taking into account a maximum possible continuous current of the at least two relays. Furthermore, a feed-in situation may be taken into account, which for example determines the continuous current with which an electric vehicle connected to the charging point may be charged. The determination (e.g. calculation) is carried out by means of a processor, for example.

For example, the relay control signal represents which relay of the at least two relays is to be opened or closed. The relay control signal is determined at least partially based on the charge control signal. For example, if the charge control signal represents a maximum charging current (continuous current) for charging the electric vehicle which is below the maximum continuous current of only one of the at least two relays, it is sufficient if only one relay is used for charging. In the case that the charge control signal represents a maximum charging current (continuous current) for charging the electric vehicle which is above the maximum continuous current of only one of the at least two relays, at least two of the at least two relays must be used to realize the maximum charging current, to give only one non-limiting example.

In an exemplary design of the method according to the first aspect, the at least two relays realize an identical continuous current value.

One of the at least two relays are common industrially used relays. In particular, each of the at least two relays is identical in construction. It is also possible to use more than two relays, for example three, four, five or more relays, which are then all connected in parallel. It is understood that in this case the relay control signal for each of the relays used is determined in such a way that it represents whether the corresponding relay is to be opened or closed.

The output of the relay control signal and/or the charge control signal is carried out, for example, by transmitting the relay control signal and/or the charge control signal, for example, by means of a communication module included, for example, by a control unit of the apparatus carrying out and/or controlling the method according to the first aspect. The initiation of the outputting of the relay control signal and/or the charge control signal is carried out, for example, by triggering a communication module, for example by the processor, such that the relay control signal and/or the charge control signal is subsequently transmitted by the communication module.

In an exemplary embodiment according to the first aspect, the outputting or the initiation of the outputting of the specific charge control signal is also effected via a pulse width modulated signal, in particular by means of a control pilot line.

Pulse width modulated (PWM) signals are regularly used by charging points (e.g. charging stations) to control a charging current with which a coupled electric vehicle is to be charged. This is done regularly via a so-called control pilot (CP) line, which is used in standard charging cables and enables a coupling e.g. between a control unit of the charging point and a control unit of the electric vehicle.

Such a CP line may for example release the current to be charged via a PWM. The corresponding PWM signals are received by the control unit of the electric vehicle and the represented value of the PWM signal is transmitted to a rectifier of the electric vehicle, so that the value set according to the PWM signal is subsequently adjusted.

A special feature here is that a current value, e.g. maximum possible charging current or continuous current, may be specified via such a CP line, so that this indirectly results in the controllability and/or adjustability of one or more relays of the charging point.

In an exemplary embodiment, the method according to the first aspect comprises the at least two relays being connected in parallel.

A version of the objective switch unit may also include other relays connected in parallel. However, two parallel-connected relays are sufficient to carry out the core of the object.

Consequently, more than two relays connected in parallel may be used for the object by means of the method according to the first aspect. This increases the maximum possible charging current with which an electric vehicle may be charged. In the event that, for example, future standards require the maximum possible charging current to be increased, the object may therefore be used in a similar way.

To give an example: up to 50 A as continuous current is possible with commercially available industrial relays. If two relays with a maximum continuous current of 50 A each are connected in parallel, two relays connected in parallel may be used instead of one large and very expensive 80 A relay (to realize the maximum possible charging current according to standards). Up to now, charging points have regularly included only one relay each. For this reason, it is planned in an exemplary embodiment to retrofit a further relay, e.g. on a circuit board (e.g. a Copper Circuit Board or Printed Circuit Board) at the charging point.

In an exemplary embodiment of the method according to the first aspect, the maximum current value with which the electric vehicle is to be charged is determined based on a predefined value I_{R,max}.

For example, the predefined value is determined according to one or more standards according to which charging point and/or electric vehicle are coordinated. At the time of application of the present object, this value I_{R,max} according to IEC 61851-1:2017 or SAE J 1772:2017-10-13 allow a maximum charging current which is 80 A.

In an exemplary embodiment, the method according to the first aspect further comprises:

Sensing a present charging current I_{L} with which the electric vehicle is charged, wherein the relay control signal is determined such that at least two relays are closed if I_{L}>value I_{R,max}.

The measuring of the present charging current I_{L} is carried out, for example, by means for recording (e.g. measuring) the present charging current I_{L}, such as for example a measuring unit. The means for detecting the present charging current I_{L} may detect it, for example, on the power line of the charging cable, to give just one non-limiting example.

In an exemplary embodiment of the method according to the first aspect, the relay control signal is determined in such a way that required switching operations of the at least two relays are substantially equally distributed over the at least two relays.

This makes it possible to divide the distribution of switching cycles (corresponds to the term switching operations) per relay between the at least two relays. By distributing the switching cycles equally among the at least two relays, for example, the respective service life of each of the at least two relays is maximized. This applies especially in the case that an electric vehicle is charged with a charging current or continuous current that is below 50 A (corresponds to the maximum continuous current of a relay). This may be limited, for example, by the fact that an earth wire cannot provide the charging point with more amount of electrical current.

In an exemplary embodiment of the method according to the first aspect, the step of determining the relay signal is divided into respectively determining a dedicated relay signal for each of the at least two relays, wherein the outputting or causing of the outputting of the determined relay control signal is further divided into outputting or causing the outputting of each of the dedicatedly determined relay signals to each of the at least two relays.

Additionally or alternatively, the relay control signal may represent a respective switching state, i.e. opened or closed, for each of the at least two relays.

The relay control signal may also include or represent addressing information or identification information for each of the at least two relays, or for the relay to be switched by the particular relay control signal, so that the at least two relays can be switched separately. The addressing information or the identification information thereby allows an unambiguous determination of the relay which is to be switched. The determination (e.g. calculation) is carried out by means of a processor, for example.

The apparatus according to the second aspect is designed to be placed at or in a charging point. This apparatus comprises at least one relay configured to detect or receive a relay control signal indicative of an opening and/or closing of at least two relays, wherein the apparatus opens or closes the at least one relay based on the relay control signal.

The relay control signal is detected or received, for example, by an apparatus that carries out and/or controls a method according to the first aspect, for example by receiving it. The apparatus according to the second aspect may, for example, verify addressing information or identification information included or represented by the relay control signal before performing the switching of the at least one relay, so that the at least one relay is switched only if addressing or identification information associated with the at least one relay corresponds to that of the relay control signal.

This may then be used, for example, to switch the at least one relay, wherein the at least one relay is opened or closed based on the relay control signal. Whether the at least one relay is open or closed may also be determined on the basis of the detected present charging current I_{L}, since this is reflected in the measurement result, for example.

In an exemplary embodiment according to the second aspect, the relay control signal is a dedicated relay control signal for the at least one relay of the apparatus.

In an exemplary embodiment according to the first aspect, at least one relay is arranged on its own circuit board.

The at least one relay, or the apparatus according to the second aspect comprising the at least one relay, is for example arranged on a separate printed circuit board. This achieves a mechanical decoupling of the functions of the at least one relay, so that it may be arranged in or at a charging point (e.g. a charging unit or a charging column) as required.

This enables, for example, to create an assembly variant of a circuit board with which an already installed and/or commissioned charging point may be retrofitted with e.g. a second relay, so that the object can subsequently be used in all aspects.

The circuit board is, for example, a Copper Circuit Board (CCB) or a Printed Circuit Board that may be assembled. This allows for example a miniaturization of the corresponding apparatus according to the second aspect, so that it may be installed modularly at a charging point (e.g. a charging station).

In an exemplary embodiment according to the first aspect, the circuit board is designed for arrangement at a charging point.

The at least one relay of the apparatus according to the second aspect is for example modularly installable (e.g. mountable) by means of the circuit board at the charging point. In this way, the at least one relay of the apparatus according to the second aspect is also exchangeable, e.g. in case of a defect or for adaptation to new (e.g. future) requirements, to name but a few non-limiting examples.

The exemplary embodiments of the present invention described above in this description should also be understood as disclosed in all combinations with each other. In particular, exemplary embodiments should be understood disclosed in relation to the different aspects.

In particular, the previous or following description of method steps according to preferred forms of execution of a method should also reveal corresponding means for carrying out the method steps by preferred forms of execution of an apparatus. Likewise, the disclosure of means of an apparatus for carrying out a method step should also reveal the corresponding method step.

Further advantageous exemplary embodiments of the invention can be found in the following detailed description of some exemplary embodiments of the present invention, in particular in connection with the figures. The figures, however, are only intended to clarify, but not to determine the scope of protection of the invention. The figures are not to scale and are merely intended to illustrate the general concept of the present invention. In particular, features contained in the figures are not intended to be regarded as a necessary element of the invention.

### BRIEF DESCRIPTION OF THE FIGURES

In the drawings:

FIG. 1 depicts a system of an exemplary embodiment according to the third aspect;

FIG. 2 depicts a flow chart of an exemplary embodiment according to a method according to the first aspect;

FIG. 3 depicts a schematic circuit diagram, as it is realized, for example, by an exemplary embodiment of a charging point according to the first aspect;

FIG. 4 is a block diagram of an exemplary embodiment of an apparatus by the second aspect; and

FIG. 5 depicts exemplary temporal characteristics of a duty cycle of a PWM signal used, for example, in a system according to FIG. 1.

### DETAILED DESCRIPTION OF SOME EXEMPLARY EMBODIMENTS OF THE INVENTION

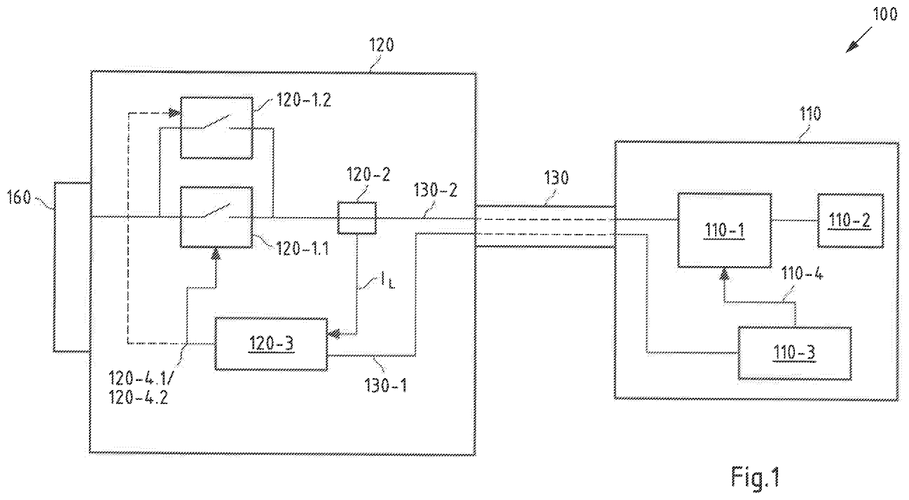

FIG. 1 shows a system of an exemplary embodiment according to the third aspect. A general structure of a system 100, where the object can be applied, is shown.

A charging point 120 (e.g. a charging station) is connected to a supply network 160. A power line leads from the supply network 160 via at least two (in FIG. 1 exactly two relays are shown) relays 120-1.1 and 120-1.-2, an optional measuring unit 120-2, a charging cable 130, a rectifier 110-1 (comprised in an electric vehicle 110) to a battery 110-2, which is also comprised in the electric vehicle 110. For reasons of clarity, it is assumed that the power line is a phase. Of course, the invention is also applicable to multi-phase, in particular two-phase, power systems.

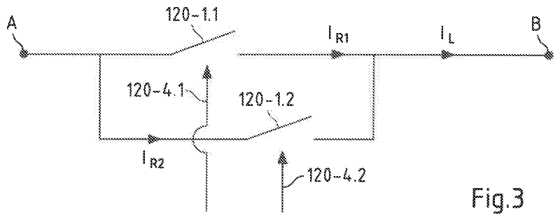

The relays 120-1.1 and 120-1.-2 may, for example, be comprised by one switch unit, or by one switch unit respectively comprising one relay each. A switch unit of the former case is shown schematically in FIG. 3.

Each relay 120-1.1 and 120-1.-2 (e.g. the switch unit) is controlled by a relay control signal 120-4.1 and 120-4.2 respectively by a control unit 120-3 comprised in the charging point 120. Alternatively, a relay control signal comprising one control command for each of the relays 120-1.1 and 120-1.-2 may be used. For example, by means of appropriate addressing information included or represented by the relay control signal, a single relay of relays 120-1.1 and 120-1.-2 may then be controlled in a dedicated manner. By means of such a relay control signal, a relay 120-1.1 and/or 120-1.-2 may be opened or closed.

The measuring unit 120-2 of charging point 120 is designed, for example, to detect (e.g. measure) a current flowing on the power line 130-2 and/or a voltage applied on the power line 130-2. This current or voltage corresponds to the current or voltage transmitted via a charging cable 130, and with which the charging point 120 is connected to the electric vehicle 110. The value measured with the measuring unit 120-2 is made available to the control unit 120-3 e.g. as a measuring signal. The measuring unit 120-2 may also be arranged in an alternative or additional embodiment between the supply network 160 and the two relays 120-1.1 and 120-1.-2 connected in parallel.

For example, the charging cable 130 comprises a CP line 130-1 in addition to the power line 130-2, wherein the CP line 130-1 operatively connects the control unit 120-3 of charging point 120 with a control unit 110-3 comprised by the electric vehicle 110. The electric vehicle further comprises a rectifier 110-1, which is controlled by the control unit 110-3 of the electric vehicle 110. The rectifier 110-1 is connected to a battery 110-2 of the electric vehicle 110.

No changes need to be made to the electric vehicle to implement the object. Thus, as in the state of the art, a charging current flowing on the power line 130-2 may be controlled and/or regulated by means of a duty cycle of a PWM signal transmitted via the CP line 130-1 from the control unit 120-3 of the charging point 120 to the control unit 110-3 of the electric vehicle. The charging point 120, on the other hand, may, for example, only switch a current on or off by opening or closing relays 120-1.1 and 120-1.-2.

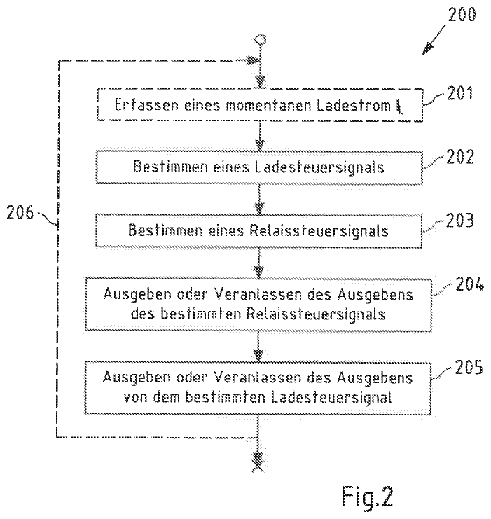

FIG. 2 shows a flowchart 200 of an example of a method according to the first aspect, which is carried out by a charging station or a charging point, for example charging station 120 from FIG. 1.

In an optional first step 201 a present charging current is recorded. The present charging current is recorded, for example, by measuring the present charging current. Alternatively, the charging current may also be obtained, for example, by detecting (e.g. measuring) the present charging current by a measuring unit (e.g. measuring unit 120-2) and then transmitting it to the apparatus which carries out and/or controls the flow chart 200 so that it receives the present charging current or a value representing it.

In a second step 202 a charge control signal is determined. The charge control signal, for example, when transmitted to an electric vehicle and the electric vehicle is connected for charging, causes the electric vehicle to set a current value represented by the determined charge control signal based on the charge control signal for charging a battery of the electric vehicle.

In a third step 203, a determination of one relay control signal, or a determination of two or more relay control signals takes place, wherein in the latter case each of these two or more relay control signals to a corresponding relay comprised by the apparatus carrying out and/or controlling flowchart 200. This could be, for example, relays 120-1.1 and 120-1.2 as shown in FIG. 1.

In a fourth step 204 there is an outputting or causing of the outputting of the specific relay control signal(s), e.g. to the at least two relays (e.g. relay 120-1.1 and 120-1.2 according to FIG. 1) comprised in the apparatus carrying out and/or controlling the flow chart 200. The relay control signal or the two or more relay control signals are transmitted, for example, from a control unit included in the apparatus (e.g. control unit 120-3 according to FIG. 1) to the corresponding relays.

In a fifth step 205 the output or causing of the output of the specific charge control signal is carried out, e.g. by outputting the charge control signal to an electric vehicle (e.g. electric vehicle 110 according to FIG. 1). The transmission of the charge control signal is carried out, for example, by a control unit comprised by the apparatus (e.g. control unit 120-3 according to FIG. 1) to the electric vehicle 110 according to FIG. 1 or to a further control unit (e.g. control unit 110-3 according to FIG. 1) which is comprised by the electric vehicle 110 according to FIG. 1. The output of the charge control signal is initiated, for example, by the control unit 120-3 according to FIG. 1 triggering the output of the charge control signal, e.g. so that a communication module, which is comprised by the control unit 120-3 according to FIG. 1, for example, outputs the charge control signal. The charge control signal is transmitted, for example, via a charging cable (e.g. charging cable 130 according to FIG. 1) that connects the apparatus and the electric vehicle. For this purpose, the charging cable includes, for example, a CP line which is used for this purpose.

Steps 201 to 205 may be repeated several times, especially several times during a charging process of an electric vehicle. This is illustrated in flowchart 200 by the return arrow with reference number 206, which points back to the beginning of flowchart 200.

FIG. 3 shows a schematic circuit diagram, as it is implemented, for example, by an exemplary embodiment of a charging point according to the second aspect.

A switch unit is shown which comprises, for example, relay 120-1.1 and relay 120-1.2 as shown in FIG. 1. Accordingly, such a switch unit 300 may be comprised by a charging point 120 as shown in FIG. 1. By means of the marked points A and B the connection of switch unit 300 within charging point 120 (e.g. a charging station) of FIG. 1 is shown. Points A and B are also shown in FIG. 1 accordingly. The relay 120-1.1 and the relay 120-1.2 are constructed identically. Therefore, both relays 120-1.1, 120-1.2 have almost the same internal resistance in their closed state. The current I_{R1} may flow through the closed relay 120-1.1. The current I_{R2} may flow through the closed relay 120-1.2. When both relays are closed, the following applies:

IR1≈IR2.

In addition, the following applies for a charging current I_{L}, which flows via the power line:

I_{L}≈I_{R1}+I_{R2}.

If the charging current I_{L} is below I_{R,max}, it is sufficient if only one relay is closed and the other relay may remain open. Now the other relay may be closed also to allow an IL above I_{R,max}.

In this case, the control unit of the charging station may control the duty cycle of the PWM signal on the CP line (see e.g. 130-1 according to FIG. 1) in such a way that it is always ensured that both relays are closed if I_{L}>I_{R,max} applies.

Verification may be implemented by waiting a certain time until the duty cycle of the PWM signal is adapted or adjusted so that I_{L}>I_{R,max}. Verification may also be implemented by the control unit using the measurement signals to determine if the other relay has been switched on (for example, due to fluctuations in the measured voltage or current).

The relay control signals 120-4.1 and 120-4.2 may be determined accordingly (see step 203 according to FIG. 2), and subsequently output to the relays 120-1.1, 120-1.2 or have their output caused (see step 205 according to FIG. 2).

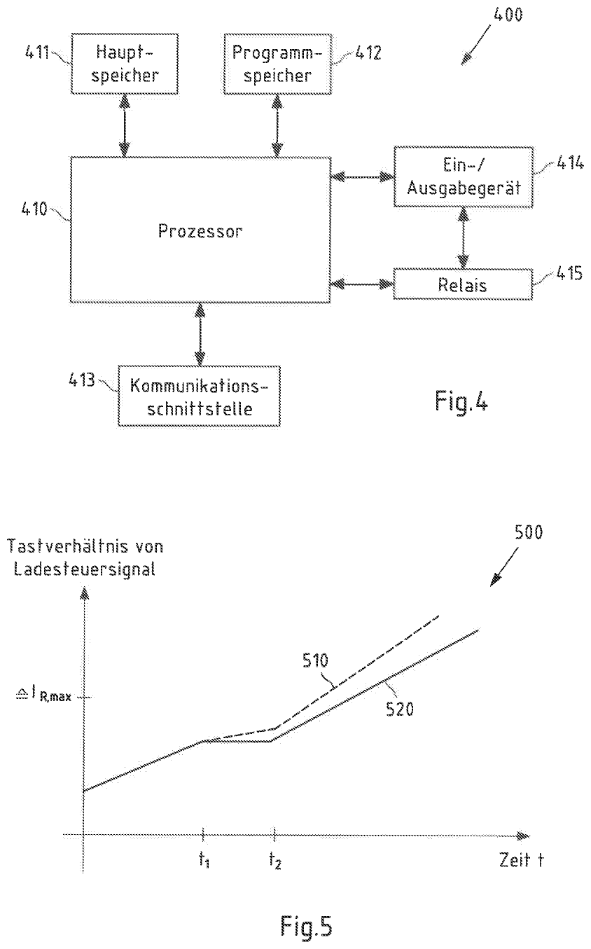

FIG. 4 shows a block diagram of an exemplary embodiment of an apparatus 400, which in particular may carry out and/or control an exemplary embodiment according to the first aspect. The apparatus 400 is for example an apparatus according to the first aspect. The apparatus 400 may in particular carry out and/or control the flow chart 200 from FIG. 2.

The apparatus 400 may insofar be or comprise for example a computer, a desktop computer, a server, a server cloud (at least two servers which at least partially together provide a service), a thin client or a portable computer (mobile device), such as a laptop computer, a tablet computer, a personal digital assistant (PDA) or a smartphone, tablet, or a combination thereof, so that in particular steps 201 to 205 of the flow chart 200 according to FIG. 2 may at least partially be carried out and/or controlled by the apparatus 400.

Processor 410 of the apparatus 400 is especially designed as a microprocessor, microcontroller, microcontroller, digital signal processor (DSP), application specific integrated circuit (ASIC) or field programmable gate array (FPGA).

Processor 410 executes program instructions stored in program memory 412 and stores, for example, intermediate results or the like in working or main memory 411. For example, the program memory 412 is a non-volatile memory such as flash memory, magnetic memory, EEPROM (electrically erasable programmable read-only memory) and/or optical memory. Main memory 411 is for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM).

Program memory 412 is preferably a local data carrier permanently connected to the apparatus 400. Examples of media that are fixed to the apparatus 400 are hard disks that are built into the apparatus 400. Alternatively, the data carrier may also be, for example, a data carrier separably connectable to the apparatus 400, such as a memory stick, a removable data carrier, a portable hard disk, a CD, a DVD and/or a floppy disk.

Program memory 412 contains, for example, the operating system of the apparatus 400, which is at least partially loaded into main memory 411 when the apparatus 400 is started and executed by processor 410. In particular, when apparatus 400 is started, at least part of the core of the operating system is loaded into main memory 411 and executed by processor 410. The operating system of apparatus 400 is, for example, a Windows, UNIX, Linux, Android, Apple iOS and/or MAC operating system. Alternatively or additionally, the apparatus 400 is configured as a so-called bare-metal implementation. Apparatuses configured as such bare-metal implementations have, for example, microcontroller-based operating systems, such as OSEK, AUTOSAR, or the like. Sometimes such apparatuses configured as such bare-metal implementations do not require an operating system. The functions provided by such an apparatus are then available without the support of an operating system. For example, a bare-metal implementation interacts with apparatus 400 at the hardware level.

In particular, the operating system allows the use of the apparatus 400 for data processing. For example, it manages resources such as main memory 411 and program memory 412, communication interface 413, input and output device 414, provides other programs with basic functions through programming interfaces, among other things, and controls the execution of programs.

Processor 410 controls the communication interface 413, which may be a network interface, for example, and may be a network card, network module and/or modem. The communication interface 413 is set up in particular to establish a connection of the apparatus 400 with other apparatuses/devices, in particular via a (wireless) communication system, for example a network, and to communicate with these devices. The communication interface 413 can, for example, receive data (via the communication system) and forward it to processor 410 and/or receive data from processor 410 and send it (via the communication system). Examples of a communication system are a local area network (LAN), a wide area network (WAN), a wireless network (e.g. according to the IEEE 802.11 standard, Bluetooth, Bluetooth Low Energy (LE) standard and/or NFC standard), a wired network, a mobile network, a telephone network and/or the Internet.

Furthermore, processor 410 may control at least one input/output device 414. An input/output device 414 is, for example, a keyboard, a mouse, a display unit, a microphone, a touch-sensitive display unit, a speaker, a reader, a drive and/or a camera. For example, input/output device 414 may receive input from a user and forward it to Processor 410 and/or receive and output information for the user from Processor 410.

Furthermore, processor 410 may control at least one relay 415 (e.g. relay 120-1.1 and/or relay 120-1.2), for example by transmitting a relay control signal to the corresponding relay. Alternatively, the relay 415 may be controlled by transmitting a relay control signal from the communication interface 413, and/or by the input/output device 414 controlling the relay 415, e.g. by means of an actuator, just to name a few non-limiting examples.

FIG. 5 shows two exemplary time curves of a duty cycle of a PWM signal, which is used, for example, in a system according to FIG. 1.

If I_{L}<I_{R,max} applies, it is sufficient if only one of two relays (e.g. relay 120-1.1 and relay 120-1.2 according to FIG. 1) is closed. In the interval 0<t<t₁ the first relay is closed and the other relay is open. At time t₁, the other relay is also closed additionally. Subsequently, it is waited until time t₂ until the duty cycle of the PWM signal is increased so that I_{L}>I_{R,max} applies. By waiting for the time interval t₂-t₁ it is ensured that the other relay is definitely closed. After time t₂, the duty cycle of the PWM signal may be increased so that I_{L}>I_{R,max} applies. The charging current is distributed equally by the objective parallel connection of two identical relays. In the ideal case, the current flows through a closed relay:

I_{R1}=I_{L}/2.

The exemplary embodiments of the present invention described in this specification and the optional features and characteristics mentioned in each case in this respect should also be understood as disclosed in all combinations with each other. In particular, unless explicitly stated otherwise, the description of a feature included in an example of an embodiment shall not be understood in the present case to mean that the feature is indispensable or essential for the function of the example. The sequence of the method steps described in this specification in the individual flowcharts is not mandatory; alternative sequences of method steps are conceivable. The method steps may be implemented in various ways, for example, implementation in software (through program instructions), hardware or a combination of both to implement the method steps is conceivable.

Terms used in the claims such as “comprise”, “have”, “include”, “contain” and the like do not exclude further elements or steps. The expression “at least partially” covers both the “partially” case and the “completely” case. The wording “and/or” should be understood to mean that both the alternative and the combination should be disclosed, i.e. “A and/or B” means “(A) or (B) or (A and B)”. The use of the indefinite article does not exclude a plural. A single apparatus may perform the functions of several units or apparatuses mentioned in the claims. Reference marks indicated in the claims are not to be regarded as limitations of the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method comprising:
determining a charge control signal indicative of a maximum current value with which an electric vehicle is to be charged;
determining a relay control signal indicative of an opening and/or closing of at least two relays comprised by a charging point, wherein the relay control signal is determined at least partially based on the charge control signal;
outputting or causing the outputting of the determined relay control signal to at least one of the at least two relays; and
outputting or causing the outputting of the specified charge control signal to the electric vehicle.

2. The method according to claim 1, wherein the outputting or the causing of the outputting of the specific charge control signal takes place via a pulse width modulated signal, in particular by means of a control pilot line.

3. The method according to claim 1, wherein the at least two relays are connected in parallel.

4. The method according to claim 1, wherein the maximum current value with which the electric vehicle is to be charged is determined based on a predefined value I_{R,max}.

5. The method according to claim 4, further comprising:
sensing a present charging current I_{L} with which the electric vehicle is charged, wherein the relay control signal is determined such that at least two relays are closed if I_{L}>value I_{R,max}.

6. The method according to claim 1, wherein the relay control signal is determined such that required switching operations of the at least two relays are substantially equally distributed over the at least two relays.

7. The method according to claim 1, wherein the step of determining the relay signal is divided into respectively determining a dedicated relay signal for each of at least two relays, wherein the outputting or causing of the outputting of the determined relay control signal is further divided into outputting or causing the outputting of each of the dedicatedly determined relay signals to each of at least two relays.

8. The method according to claim 1, wherein the at least two relays realize an identical continuous current value.

9. An apparatus for placement at or in a charging point, comprising:
at least one relay configured to detect or receive a relay control signal indicative of an opening and/or closing of at least two relays, wherein the apparatus opens or closes the at least one relay based on the relay control signal.

10. The apparatus according to claim 9, wherein the relay control signal is a dedicated relay control signal for the at least one relay of the apparatus.

11. The apparatus according to claim 9, wherein the at least one relay is arranged on a separate circuit board.

12. The apparatus according to claim 11, wherein the circuit board is designed for placement at a charging point.

13. A charging point, comprising:
at least one apparatus comprising at least one relay configured to detect or receive a relay control signal indicative of an opening and/or closing of at least two relays, wherein the apparatus opens or closes the at least one relay based on the relay control signal; and
means for carrying out and/or controlling a method according to claim 1.

14. The charging point according to claim 13, wherein the charging point is a charging station.

15. A system, comprising:
at least one charging point according to claim 13; and
an electric vehicle configured to detect or receive the charge control signal, wherein after the detection or receipt of the charge control signal, the electric vehicle adjusts the maximum current value of the charge control signal.
